(19) United States
(12) Patent Application Publication
(10) Pub. No.: US 2011/0139121 A1
(43) Pub. Date: Jun. 16, 2011

(54) FUEL INJECTOR AND METHOD FOR PRODUCING A VALVE SEAT FOR A FUEL INJECTOR

(76) Inventors: Juergen Hackenberg, Sachsenheim (DE); Armin Glock, Urbach (DE)

(21) Appl. No.: 12/305,179

(22) PCT Filed: Oct. 17, 2007
(86) PCT No.: PCT/EP2007/061059

§ 371 Date: Feb. 25, 2009

(30) Foreign Application Priority Data
Dec. 5, 2006 (DE) 10 2006 057 279.3

(51) Int. Cl. F02M 63/00; B23P 17/00

(52) U.S. Cl. 123/445; 29/890.1

(57) ABSTRACT

A fuel injector, which has a valve-seat body with a fixed valve-seat surface, a valve-closure member cooperating with the valve seat for the opening and closing of the valve. The valve-seat body is accommodated in a longitudinal opening of a valve-seat support and fixedly joined thereto. An atomizer front piece is galvanically premolded directly on a lower end face of the valve-seat body in an adhesive manner. At least one spray-discharge orifice is provided in the atomizer front piece, which preferably widens in a funnel shape in the downstream direction. The fuel injector is particularly suitable for use in fuel-injection systems of mixture-compressing internal combustion engines having externally supplied ignition.

### FIELD OF THE INVENTION

The present invention relates to a fuel injector, and a method for producing a valve seat for a fuel injector.

### BACKGROUND INFORMATION

A fuel injector having a spherical valve-closure member which cooperates with a planar valve-seat surface of a valve-seat body is described in German Patent Application No. DE 40 26 721 A1. With the aid of a welding seam, a spray-orifice plate is fixedly joined to the valve-seat body at its downstream end face. This valve-seat component made up of spray-orifice plate and valve-seat body is sealingly mounted in a valve-seat support. The fixed connection between the valve-seat component and the valve-seat support is implemented by a circumferential welding seam at a support edge of the spray-orifice plate, which is radially stressed. The welding seams are produced by laser welding, in particular.

U.S. Pat. No. 5,570,841 A1 describes a fuel injector which has a two-layer spray-orifice stack downstream from its valve-seat element. The orifice-plate stack is loosely inserted into a longitudinal opening of a valve-seat support and sealed from the valve-seat element with the aid of a sealing ring. Provided downstream from this orifice-plate array is a securing element, which ensures that the orifice plates are pressed against the valve-seat element and retained there. Additional support for this entire array is provided by an inwardly projecting collar of the valve-seat support, which extends under the securing element in the manner of a bead. In such an array, there is the danger that the secure and stable installation position of the nozzle-side components in the valve-seat support cannot be ensured over the service life of the fuel injector.

### SUMMARY

An example fuel injector according to the present invention may have the advantage of a simple and cost-effective solution for obtaining a permanent, secure connection between a valve-seat body and an atomizer front piece, which assumes the function of a known spray-orifice disk. The atomizer front piece is advantageously integrated on the valve-seat body in such a way that any displacement of the components as well as warping of valve-seat body and/or atomizer front piece (spray-orifice disk) is ruled out in that welded seams are avoided, so that the sealing function of the valve is reliably ensured over the entire service life. According to the present invention, this is achieved by galvanically premolding the atomizer front piece directly on the valve-seat body in an adhesive manner.

It is especially advantageous if the valve-seat body together with the atomizer front piece premolded thereon forms a valve-seat component, which is able to be introduced into a valve-seat support of the fuel injector and mounted thereon in an uncomplicated manner.

It is advantageous to provide at least one spray-discharge orifice in the atomizer front piece, which preferably widens in a funnel shape in the downstream direction.

An example method of the present invention for producing a valve seat for a fuel injector may have the advantage of avoiding any thermal stressing of the valve-seat body and of completely dispensing with conventional method steps for joining a spray-orifice plate to the valve seat. Instead, the atomizer front piece is constructed directly on the valve-seat body by a microgalvanic forming process. This process produces a planar, gap-free connection between the atomizer front piece and the valve-seat body at adhesive strength values of up to 450 N/mm² as they are customary for electrochemically deposited metals.

It is especially advantageous if a fitted metal foil is applied directly on a lower end face of the valve-seat body using a conductive adhesive agent or a conductive foil resist. Via the size, form and dimensions of the metal foil or the foil resist, the size, form and dimensions of a flow-exposed cavity inside the future atomizer front piece are able to be defined. The design of the flow-exposed cavity is freely selectable and may be implemented as a large surface or as multiple channels, for example.

### BRIEF DESCRIPTION OF THE DRAWINGS

Exemplary embodiments of the present invention are depicted in simplified form in the figures and explained in greater detail below.

FIG. 1 shows a partially shown conventional fuel injector.

FIGS. 2 to 4 show method steps for producing a valve-seat body according to an example embodiment of the present invention, which includes an integrated spray-orifice plate as an atomizer front piece for a fuel injector.

FIG. 5 shows a schematic view from below of the valve-seat body having two flow-exposure variants in the premolded atomizer front piece.

### DETAILED DESCRIPTION OF EXAMPLE EMBODIMENTS

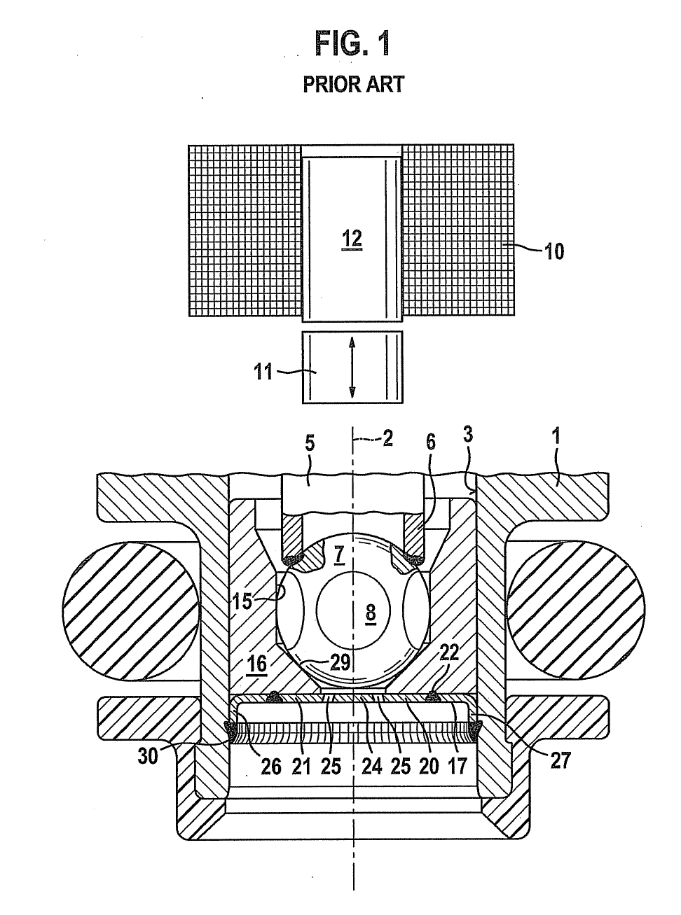

FIG. 1 partially shows a conventional valve in the form of an injector for fuel injection systems of mixture-compressing internal combustion engines having externally supplied ignition. The injector has a tubular valve-seat support 1, in which a longitudinal opening 3 is formed concentrically to a longitudinal valve axis 2. Disposed in longitudinal opening 3 is an, e.g., tubular valve needle 5, which is connected at its downstream end 6 to a spherical valve-closure member 7 on whose periphery, for example, five flattened regions 8 are provided.

The fuel injector is actuated in a conventional manner, e.g., electromagnetically. Nevertheless, it is also possible to use piezoelectric or magnetorestrictive actuators as exciter elements. A schematically sketched electromagnetic circuit is provided for an axial movement of valve needle 5, and thus for the opening of the fuel injector against the spring force of a (not shown) restoring spring, or for the closing of the fuel injector, the electromagnetic circuit including a solenoid coil 10, an armature 11 and a core 12. Armature 11 is joined to the end of valve needle 5 facing away from valve-closure member 7 by a welding seam formed by laser, for instance, and points to core 12. Solenoid coil 10 surrounds core 12, which constitutes the end, enclosed by solenoid coil 10, of an intake nipple (not shown further), which supplies the fuel to be metered with the aid of the valve.

A guide opening 15 of a valve-seat body 16 guides valve-closure member 7 during the axial movement. Cylindrical valve-seat body 16 is sealingly mounted, by welding, in the downstream end of valve-seat support 1 facing away from core 11, in longitudinal opening 3 extending concentrically to longitudinal valve axis 2. The circumference of valve-seat body 16 has a slightly smaller diameter than longitudinal opening 3 of valve-seat support 1. At its lower end face 17 facing away from valve-closure member 7, valve-seat body 16 is concentrically and permanently connected to a base part 20 of a spray-orifice plate 21 having a cup-shaped form, for example.

The connection of valve-seat body 16 and spray-orifice plate 21 is implemented by a circumferential and sealing first welding seam 22 formed by laser, for instance. In its central region 24, base part 20 of spray-orifice plate 21 has at least one, for example four, spray-discharge orifices 25 formed by eroding or stamping.

Adjoining base part 20 of cup-shaped spray-orifice plate 21 is a circumferential support edge 26, which extends away from valve-seat body 16 in the axial direction and is conically bent in the outward direction up to its end 27. Support edge 26 exerts a radial spring effect on the wall of longitudinal opening 3. When the valve-seat component made up of valve-seat body 16 and spray-orifice plate 21 is slipped into longitudinal opening 3 of valve-seat support 1, the formation of shavings at the valve-seat component and longitudinal opening 3 is prevented. At its end 27, support edge 26 of spray-orifice plate 21 is joined to the wall of longitudinal opening 3 by a circumferential and sealing second welding seam 30, which is produced by laser, for example.

The insertion depth of the valve-seat component, made up of valve-seat body 16 and cup-shaped spray-orifice plate 21, in longitudinal opening 3 determines the magnitude of the travel of valve needle 5, since the one end position of valve needle 5 in the non-energized state of solenoid coil 10 is defined by the contact of valve-closure member 7 with valve seat surface 29 of valve-seat body 16. When solenoid coil 10 is energized, the other end position of valve needle 5 is defined by, e.g., the contact of armature 11 with core 12. The path between these two end positions of valve needle 5 therefore constitutes the travel.

Spherical valve-closure member 7 cooperates with valve-seat surface 29 of valve-seat body 16, valve-seat surface 29 tapering frustoconically in the flow direction and being formed between guide opening 15 and lower end face 17 of valve-seat body 16 in the axial direction.

The locally and temporally unequal energy introduction during the welding operation for the purpose of obtaining welding seams 22, 30 may cause warping of valve-seat body 16 and thus of valve-seat surface 29 as well, which could have a detrimental effect on the sealing function of the valve. The rotundity of the sealing region at valve-seat surface 29, which could worsen following the welding process, may be utilized as measured variable for the warping. Moreover, the welding may also cause warping of spray-orifice plate 21, in the negative case in central region 24 of base part 20 as well, with the result that spray-discharge orifices 25 deform, which may cause a change in the jet angle and/or a change in the flow rate. This leads to greater production variances of the mentioned valve parameters.

Therefore, according to an example embodiment of the present invention, a spray-orifice plate 21 is integrated on a valve-seat body 16 in such a way that any displacement of the components as well as warping of valve-seat body 16 and/or spray-orifice plate 21 is prevented by avoiding welding seams, so that the sealing function of the valve is reliably ensured across the entire service life.

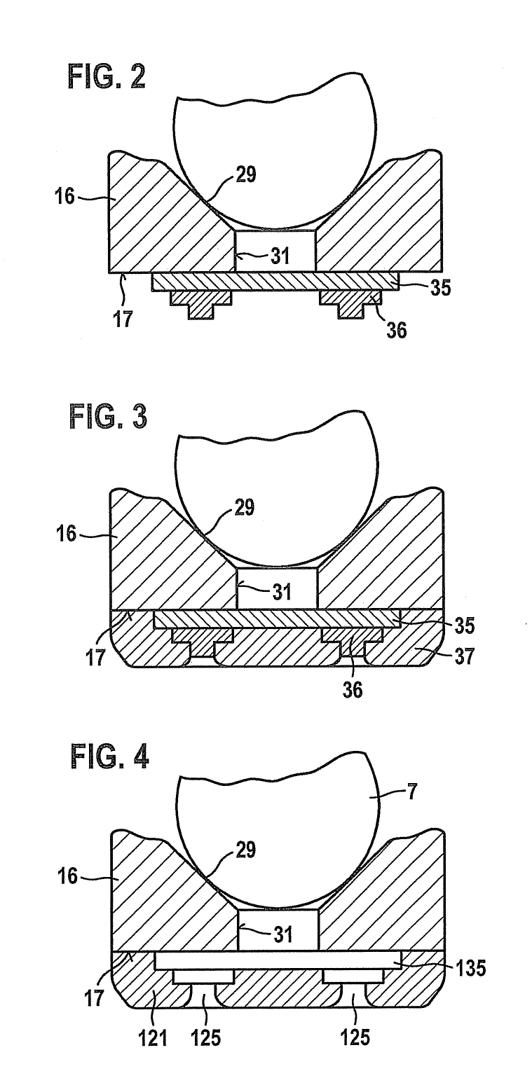

FIGS. 2 through 4 schematically illustrate method steps for producing a valve-seat body 16 according to an example embodiment of the present invention, which has an integrated spray-orifice plate 21 for a fuel injector. Spray-orifice plate 21 is referred to as atomizer front piece 121 in the following text since the structure premolded on valve-seat body 16 also may deviate considerably from a disk shape. Atomizer front piece 121 is characterized by having at least one spray-discharge orifice 125, which defines the jet form, the jet angle as well as the flow rate via its size, contour, opening width and inclination.

The example method according to the present invention for producing a valve seat for a fuel injector has the great advantage of avoiding any thermal stressing of valve-seat body 16 and of completely dispensing with conventional method steps for joining spray-orifice plate 21 to valve-seat body 16. Instead, atomizer front piece 121 is constructed directly on valve-seat body 16 by a microgalvanic forming process. This process produces a planar, gap-free connection of atomizer front piece 121 and valve-seat body 16 at adhesive strength values of up to 450 N/mm² as they are customary for electrochemically deposited metals.

The main process steps for producing the valve-seat component made up of valve-seat body 16 and atomizer front piece 121 are described in greater detail on the basis of FIGS. 2 through 4. To begin with, a valve-seat body 16 is provided, which ideally already has a finished valve-seat surface 29. Furthermore, valve-seat body 16 is already provided with a discharge opening 31 formed downstream from valve-seat surface 29, which terminates at lower end face 17 of valve-seat body 16. Atomizer front piece 121 will subsequently be formed at this lower end face 17. To this end, a metal foil 35 adapted to valve-seat body 16 is applied on end face 17 using a conductive adhesive agent. As an alternative, it is also possible to apply conductive foil resist directly on end face 17. The size, form and dimensions of metal foil 35 define the size, form and dimensions of flow-exposed cavity 135 inside future atomizer front piece 121. Using photolithography, a negative pattern of the subsequent atomizer front piece 121 is produced. The photolithography includes the application of a photo resist 36 in the form of patterned photoresist columns, exposure of photoresist 26, as well as developing of photoresist 36.

The metal pattern to be produced is to be inversely transferred to photoresist 36 with the aid of a photolithographic mask. One possibility is to expose photoresist 36 directly, via the mask, using UV exposure (UV-depth lithography by a UV lamp or UV LED). Furthermore, laser ablation is another option, in which material of photoresist 36 is explosively removed by laser once a mask has been applied. After UV-exposed photoresist 36 has been developed, or after other methods (dry etching, ablation) have been used, a pattern defined by the mask results in photoresist 36, which constitutes a negative pattern for the future atomizer front piece 121 (FIG. 2).

Depending on the desired pattern of atomizer front piece 121, an additional layer of photoresist 36 is applied, exposed and developed.

The following method step of galvanic formation involves an electrochemical metal deposition. The deposition of metal 37 begins simultaneously on the exposed annular surface of lower end face 17 of valve-seat body 16 and on metal foil 35 or on the conductive foil resist. As a result of the electroplating, metal 37 is applied closely to the contour of the negative pattern of photoresist 36, so that the predefined contours are reproduced therein true to form. To produce patterns of atomizer front piece 121 that include multiple functional planes, the height of the galvanic layer of metal 37 should largely correspond to the height of photoresist 36. The selection of the material to be deposited depends on the particular specifications for atomizer front piece 121, in which context factors such as mechanical stability, chemical resistance, welding ability and others are of special importance. As a rule, Ni, NiCo, NiFe or Cu are used but other metals and alloys are possible as well (FIG. 3).

Finally, metal foil 35 and photoresist 36 are dissolved from the pattern grown from metal 37. This may be accomplished by, e.g., a KOH treatment or an oxygen plasma or by a solvent (such as acetone) in the case of polyimides. These processes of dissolving photoresist 36 are generally known by the generic term of “stripping”. Metal foil 35 is preferably made of aluminum, which is also dissolved during stripping. Once photoresist 36 as well as metal foil 35 have been removed, an atomizer front piece 121 directly premolded on valve-seat body 16 is available, which includes at least one, but usually a multitude of spray-discharge orifices 125. The growth of metal 37 during the galvanic formation takes place in such a way that, for example, curved edge regions remain when the metal deposition is stopped, through which spray-discharge orifices 125 widen in a funnel shape in the downstream direction (FIG. 4).

Valve-seat body 16 together with atomizer front piece 121 forms a valve-seat component, which is able to be introduced into longitudinal opening 3 of a valve-seat support 1 where is may be mounted.

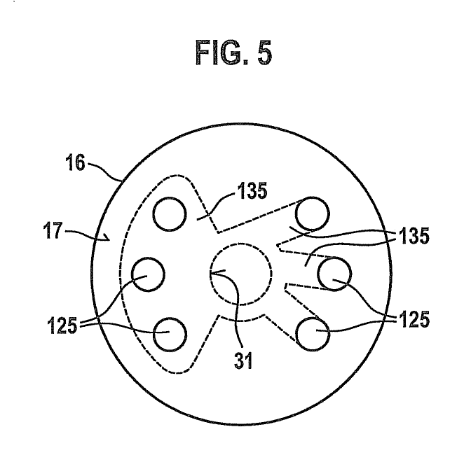

FIG. 5 shows a schematic view from below of valve-seat body 16 with two flow-exposure variants in premolded atomizer front piece 121. While the left side shows an embodiment having a single flow-exposed cavity 135 in the shape of a circle segment, from whence all spray-discharge orifices 125 are supplied with the fluid to be spray-discharged, the right side of FIG. 5 shows a variant in which each spray-discharge orifice 125 is connected to a single, channel-like flow-exposed cavity 135. For the latter design variant, it is advantageous if a conductive foil resist is applied directly on lower end face 17 of valve-seat body 16 and patterned as negative form of these channel-type flow-exposed cavities 135. This is followed by a second patterning step using conventional photoresist 36 to produce spray-discharge orifices 125 in the manner described on the basis of FIGS. 2 through 4.

1-14. (canceled)

15. A fuel injector for a fuel-injection system of an internal combustion engine, comprising:
a valve-seat body having a fixed valve seat;
a valve-closure member cooperating with the valve seat of the valve-seat body; and
an atomizer front piece galvanically premolded directly on the valve-seat body in an adhesive manner.

16. The fuel injector as recited in claim 15, wherein the fuel injector has a longitudinal valve axis.

17. The fuel injector as recited in claim 15, wherein a connection of the atomizer front piece and the valve-seat body has an adhesive strength of up to 450 N/mm².

18. The fuel injector as recited in claim 15, wherein the atomizer front piece includes at least one flow-exposed cavity, which is in the form of one of a large surface or channels.

19. The fuel injector as recited in claim 15, wherein the atomizer front piece includes at least one spray-discharge orifice, which widens in a form of a funnel in a downstream direction.

20. The fuel injector as recited in claim 15, wherein the valve-seat body together with the atomizer front piece forms a valve-seat component, which is able to be introduced into a longitudinal opening of a valve-seat support.

21. A method for producing a valve seat for a fuel injector for a fuel-injection system of an internal combustion engine, the fuel injector having a longitudinal valve axis, a valve-seat body having a fixed valve seat, and a valve-closure member which cooperates with the valve seat of the valve-seat body, the method comprising:
providing the valve-seat body;
galvanically premolding an atomizer front piece directly on the valve-seat body in an adhesive manner; and
installing a valve-seat component made up of the valve-seat body and the atomizer front piece, in the fuel injector.

22. The method as recited in claim 21, further comprising:
applying a fitted metal foil on a lower end face of the valve-seat body using a conductive adhesive bonding agent.

23. The method as recited in claim 21, further comprising:
applying a conductive foil resist on a lower end face of the valve-seat body.

24. The method as recited in claim 23, further comprising:
using photolithography to form the atomizer front piece, including applying a photo resist in a form of patterned photo-resist columns, exposing the photo resist, and developing the photo resist.

25. The method as recited in claim 24, wherein the exposing is implemented via a mask using UV exposure or laser.

26. The method as recited in claim 25, wherein an electrochemical metal deposition begins at the lower end face of the valve-seat body and on the conductive foil resist, from whence growth about the photo resist takes place.

27. The method as recited in claim 26, wherein one of Ni, NiCo, NiFe or Cu is used for the metal deposition.

28. The method as recited in claim 25, wherein the galvanic premolding of the atomizer front piece is ended by dissolving the conductive foil resist and the photoresist.

29. The method as recited in claim 21, wherein the installing includes inserting the valve-seat component forming the valve-seat body together with the atomizer front piece into a longitudinal opening of a valve-seat support and fixing it in place there.
